(19) United States
(12) Patent Application Publication
(10) Pub. No.: US 2010/0321347 A1
(43) Pub. Date: Dec. 23, 2010

(54) PLASMA DISPLAY PANEL AND PLASMA DISPLAY APPARATUS

(75) Inventors: Kirack Park, Gyoungsangbuk-do (KR); Jongwoon Bae, Gyoungsangbuk-do (KR)

Correspondence Address: KED & ASSOCIATES, LLP, P.O. Box 221200, Chantilly, VA, 20153-1200, US

(73) Assignee: LG ELECTRONICS INC, Seoul (KR)

(21) Appl. No.: 12/517,977

(22) PCT Filed: Dec. 6, 2007
(86) PCT No.: PCT/KR2007/006327

§ 371 Date: Jun. 5, 2009

(30) Foreign Application Priority Data
Dec. 8, 2006 (KR) 10-2006-0125127

(51) Int. Cl. H01J 17/49; H01J 61/42; G09G 5/00

(52) U.S. Cl. 345/204; 313/587; 313/485

(57) ABSTRACT

A plasma display panel according to the present invention includes a front panel including a first electrode, a second electrode, and an upper dielectric layer covering the first and second electrodes, and a rear panel including a lower dielectric layer covering a third electrode. An interval between the first electrode and the second electrode ranges from 0.4 to 0.95 times an interval between the upper dielectric layer and the lower dielectric layer.

### TECHNICAL FIELD

The present invention relates to a plasma display panel and a plasma display apparatus.

### BACKGROUND ART

A plasma display apparatus includes a plasma display panel including electrodes and a driver supplying driving signals to the electrodes of the plasma display panel.

Barrier ribs of the plasma display panel partition discharge cells, and a phosphor layer is coated between the barrier ribs. The driver supplies driving signals to the discharge cells through the electrodes.

A discharge occurs inside the discharge cell due to the driving signals. The discharge occurs by the driving signals supplied to the discharge cell, and thus generates vacuum ultraviolet rays from a discharge gas filled in the discharge cell. The vacuum ultraviolet rays allow a phosphor coated inside the discharge cell to emit light, and thus generating visible light. An image is displayed on the screen of the plasma display panel due to the visible light.

### DISCLOSURE

### Technical Problem

The present invention provides a plasma display panel and a plasma display apparatus capable of improving the image quality and the driving efficiency.

### Technical Solution

A plasma display panel according to the present invention comprises a front panel including a first electrode, a second electrode, and an upper dielectric layer covering the first and second electrodes, and a rear panel including a lower dielectric layer covering a third electrode, wherein an interval between the first electrode and the second electrode ranges from 0.4 to 0.95 times an interval between the upper dielectric layer and the lower dielectric layer.

A plasma display apparatus according to the present invention comprises a plasma display panel including a front panel including a first electrode, a second electrode, and an upper dielectric layer covering the first and second electrodes, and a rear panel including a lower dielectric layer covering a third electrode, and a driver that supplies sustain signals overlapping each other to the first electrode and the second electrode, wherein an interval between the first electrode and the second electrode ranges from 0.4 to 0.95 times an interval between the upper dielectric layer and the lower dielectric layer.

### ADVANTAGEOUS EFFECTS

A plasma display panel and a plasma display apparatus according to the present invention prevent the appearance of spotted patterns to improve the image quality and the driving efficiency.

### DESCRIPTION OF DRAWINGS

FIG. 1 shows a plasma display apparatus according to an exemplary embodiment of the present invention;

FIGS. 2 and 3 shows a plasma display panel according to the exemplary embodiment of the present invention;

FIG. 4 is a diagram for explaining an interval between first and second electrodes and an interval between upper and lower dielectric layers;

FIG. 5 is a diagram for explaining a case where an interval between first and second electrodes is larger than an interval between upper and lower dielectric layers;

FIG. 6 shows a luminance and the image quality depending on an interval between first and second electrodes and an interval between upper and lower dielectric layers;

FIG. 7 is a diagram for explaining a height of a barrier rib and an interval between first and second electrodes;

FIG. 8 shows the structure of first and second electrodes;

FIG. 9 illustrates a method for representing a gray scale in the plasma display apparatus according to the exemplary embodiment of the present invention;

FIG. 10 illustrates an operation of a driver of FIG. 1;

FIG. 11 illustrates a first implementation of a sustain signal;

FIG. 12 illustrates a second implementation of a sustain signal;

FIG. 13 illustrates a third implementation of a sustain signal;

FIG. 14 illustrates a fourth implementation of a sustain signal;

FIG. 15 illustrates a fifth implementation of a sustain signal; and

FIG. 16 illustrates a sixth implementation of a sustain signal.

### BEST MODE

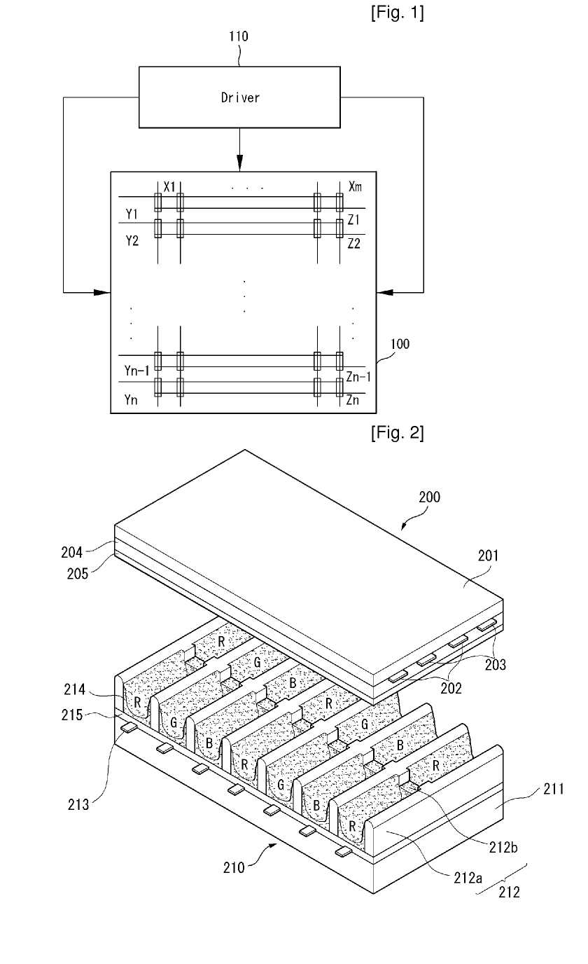

As shown in FIG. 1, a plasma display apparatus according to an exemplary embodiment of the present invention includes a plasma display panel 100 and a driver 110.

The plasma display panel 100 includes first electrodes Y1 to Yn and second electrodes Z1 to Zn that are parallel to each other, and third electrodes X1 to Xm intersecting the first electrodes Y1 to Yn and the second electrodes Z1 to Zn.

The driver 110 supplies driving signals to the electrodes of the plasma display panel 100. For instance, the driver 110 supplies sustain signals to the first electrodes Y1 to Yn and the second electrodes Z1 to Zn during a sustain period of a subfield. The driver 110, as shown in FIG. 1, may be formed on one board, or on a plurality of boards.

As shown in FIG. 2, the plasma display panel of FIG. 1 includes a front panel 200 and a rear panel 210. The front panel 200 includes a front substrate 201, a first electrode 202, a second electrode 203, an upper dielectric layer 204, and a protective layer 205. The first electrode 202 and the second electrode 203 are positioned on the front substrate 201 parallel to each other. The upper dielectric layer 204 covers the first electrode 202 and the second electrode 203 and insulates the first electrode 202 and the second electrode 203. The protective layer 205 is positioned on the upper dielectric layer 204, protects the first electrode 202 and the second electrode 203, and increases the driving efficiency.

The rear panel 210 includes a rear substrate 211, a third electrode 213, a lower dielectric layer 215, a barrier rib 212, and a phosphor layer 214.

The third electrode 213 is positioned on the rear substrate 211 to intersect the first electrode 202 and the second electrode 203. The lower dielectric layer 215 insulates between the third electrodes 213. The barrier rib 212 is positioned on the lower dielectric Layer 215 and partitions discharge cells. The barrier rib 212 may include a first barrier rib 212a positioned parallel to the third electrode 213, and a second barrier rib 212b positioned to intersect the third electrode 213. A height of the first barrier rib 212a may be larger than a height of the second barrier rib 212b, and thus an exhaust characteristic of the plasma display panel is improved. The phosphor layer 214 is coated between the barrier ribs 212. The phosphor layer 214 further includes a red phosphor layer R, a green phosphor layer G, and a blue phosphor layer B. A white phosphor layer or a yellow phosphor layer may be further coated.

Widths of red, green, and blue discharge cells, in which the red phosphor layer R, the green phosphor layer G, and the blue phosphor layer B are coated, respectively, may be substantially equal to one another.

The width of at least one of the red, green, and blue discharge cells may be different from the widths of the other discharge cells. For instance, the width of the red discharge cell may be smaller than the widths of the green and blue discharge cells. The width of the green discharge cell may be substantially equal to or different from the width of the blue discharge cell. It is possible to adjust a color temperature of an image depending on the widths of the discharge cells.

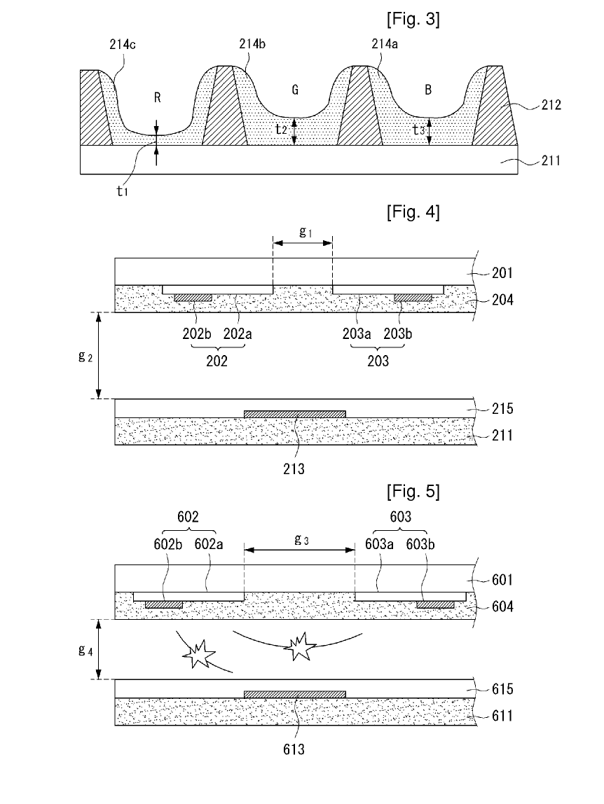

As shown in FIG. 3, a thickness of at least one of red, green, and blue phosphor layers 214c, 214b, and 214a may be different from thicknesses of the other phosphor layers. For instance, thicknesses t2 and t3 of the green and blue phosphor layers 214b and 214a may be larger than a thickness t1 of the red phosphor layer 214c. The thickness t2 of the green phosphor layer 214b may be substantially equal to or different from the thickness t3 of the blue phosphor layer 214a. The thicknesses t1, t2, and t3 of the red, green, and blue phosphor layers 214c, 214b, and 214a may lie in a range between 8 μm and 20 μm so as to improve the driving efficiency. When the thicknesses t1, t2, and t3 lies in a range between 15 μm and 20 μm, the driving efficiency is further improved.

As shown in FIG. 4, the first electrode 202 and the second electrode 203 are spaced apart from each other with a predetermined interval g1 therebetween. Further, the upper dielectric layer 204 and the lower dielectric layer 215 are spaced apart from each other with a predetermined interval g2 therebetween. The interval g1 between the first electrode 202 and the second electrode 203 is smaller than the interval g2 between the upper dielectric layer 204 and the lower dielectric layer 215. The interval g2 between the upper dielectric layer 204 and the lower dielectric layer 215 may be the shortest distance between the upper dielectric layer 204 and the lower dielectric layer 215 inside the discharge cell. FIG. 4 shows the rear panel 210 rotated by 90° for the convenience of explanation, and the barrier rib and the phosphor layer are omitted in FIG. 4.

For instance, as shown in FIG. 4, in case that the first electrode 202 and the second electrode 203 each include transparent electrodes 202a and 203a and bus electrodes 202b and 203b, the interval between the first electrode 202 and the second electrode 203 may be an interval between the transparent electrodes 202a and 203a.

The transparent electrodes 202a and 203a are formed of a transparent material such as indium-tin-oxide (ITO), and the bus electrodes 202b and 203b are formed of a metal material such as silver (Ag).

The first electrode 202 and the second electrode 203 may further include a black layer darker than the transparent electrodes 202a and 203a and the bus electrodes 202b and 203b.

As shown in FIG. 5, in case that an interval g3 between a first electrode 602 and a second electrode 603 is larger than an interval g4 between an upper dielectric layer 604 and a lower dielectric layer 615, an unnecessary discharge may occur between the first electrode 602 and a third electrode 613 or between the second electrode 603 and the third electrode 613 while a discharge occurs between the first electrode 602 and the second electrode 603.

For instance, if sustain signals are supplied to the first electrode 602 and the second electrode 603 during a sustain period of a subfield to be described later, a sustain discharge has to occur between the first electrode 602 and the second electrode 603. However, as shown in FIG. 5, in case that the interval g3 between the first electrode 602 and the second electrode 603 is larger than the interval g4 between a front substrate 601 and a rear substrate 611, a discharge may occur between the first electrode 602 and the third electrode 613 or between the second electrode 603 and the third electrode 613 during the sustain period. Hence, the discharge may be unstable, and thus the driving efficiency can be reduced.

Further, an unnecessary discharge may occur between the first electrode 602 and the third electrode 613 or between the second electrode 603 and the third electrode 613 as well as the sustain discharge generated between the first electrode 602 and the second electrode 603 in one discharge cell during the sustain period. Therefore, stopped patterns appear due to a difference between a luminance of the discharge cell where the sustain discharge occurs and a luminance of the discharge cell where the sustain discharge and the unnecessary discharges occur, thereby worsening the image quality.

On the other hand, as described with reference to FIG. 4, in case that the interval g1 between the first electrode 202 and the second electrode 203 is smaller than the interval g2 between the upper dielectric layer 204 of the front panel 200 and the lower dielectric layer 215 of the rear panel, an unnecessary discharge is suppressed from occurring between the first electrode 202 and the third electrode 213 or between the second electrode 203 and the third electrode 213 while the discharge occurs between the first electrode 202 and the second electrode 203. Hence, the driving efficiency is improved. Further, because the spotted patterns do not appear, the image quality is improved.

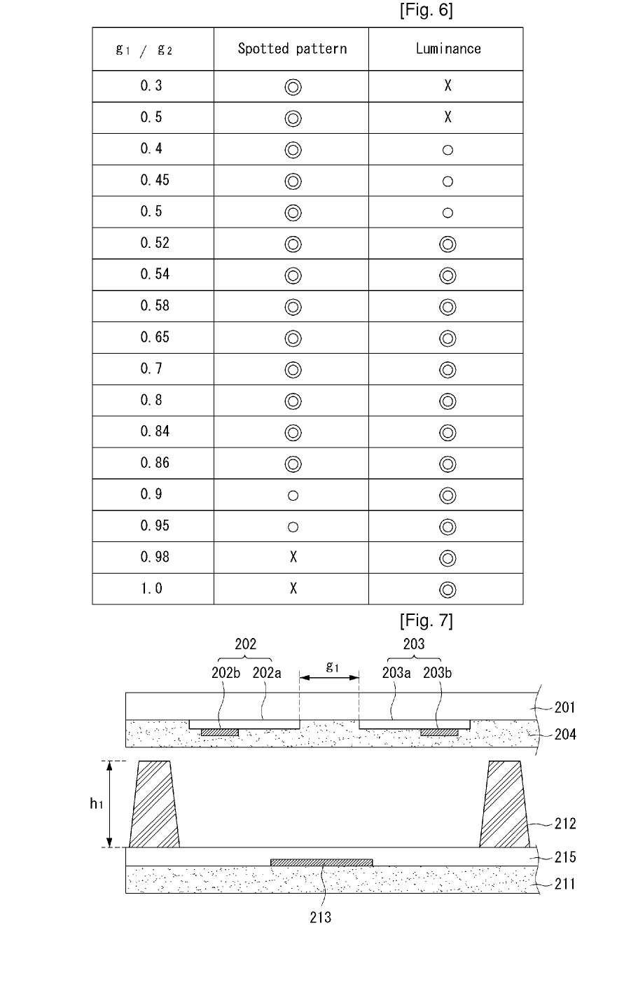

FIG. 6 shows a table measuring the image quality and a luminance depending on spotted patterns appearing on an image displayed when a ratio g1/g2 of the interval g1 between the first electrode and the second electrode to the interval g2 between the upper dielectric layer of the front panel and the lower dielectric layer of the rear panel changes from 0.3 to 1.0. In FIG. 6, X, ◯, and ⊚ indicate the reading of “bad”, “good”, and “excellent” of the image quality and the luminance depending on the spotted patterns on the image, respectively.

When the ratio g1/g2 ranges from 0.3 to 0.35 (i.e., when the interval g1 ranges from 0.3 to 0.35 times the interval g2), a positive column region of a discharge is not used because the interval g1 between the first electrode and the second electrode is excessively small. Therefore, the luminance is bad.

On the other hand, when the ratio g1/g2 ranges from 0.4 to 0.5, the luminance is good because a positive column region of a discharge is used. When the ratio g1/g2 is equal to or more than 0.52, the luminance is excellent because a positive column region of a discharge is sufficiently used.

When the interval g1 between the first electrode and the second electrode ranges from 0.3 to 0.5 times the interval between the upper dielectric layer and the lower dielectric layer, because the interval g1 between the first electrode and the second electrode is small, an unnecessary discharge is prevented from occurring between the first electrode and the third electrode or between the second electrode and the third electrode. Hence, the spotted patterns are suppressed from appearing, and the image quality is excellent. When the ratio g1/g2 ranges from 0.9 to 0.95, the generation of unnecessary discharge is reduced and the appearance of spotted patterns is further reduced. Hence, the image quality is good.

On the other hand, when the ratio g1/g2 is equal to or more than 0.98, because the interval g1 between the first electrode and the second electrode is excessively wide, the appearance of spotted patterns increases as shown in FIG. 5.

As can be seen from the table of FIG. 6, when the interval g1 between the first electrode and the second electrode ranges from 0.4 to 0.95 times the interval g2 between the upper dielectric layer and the lower dielectric layer, the image quality and the driving efficiency are improved. Further, when the interval g1 between the first electrode 202 and the second electrode 203 ranges from 0.52 to 0.86 times the interval g2 between the upper dielectric layer and the lower dielectric layer, the excellent image quality and the excellent driving efficiency can be provided.

As shown in FIG. 7, the rear panel 210 includes the barrier rib 212 partitioning the discharge cells. The barrier rib 212 has a first height h1. The interval g1 between the first electrode 202 and the second electrode 203 may be smaller than the height h1 of the barrier rib 212, and the height h1 of the barrier rib 212 may be substantially equal to the interval between the upper dielectric layer 204 and the lower dielectric layer 205. The height h1 of the barrier rib 212 may be a height of the first barrier rib 212a of FIG. 2. FIG. 7 shows the rear panel 210 rotated by 90° for the convenience of explanation.

As described with reference to FIG. 6, in case that the interval g1 between the first electrode 202 and the second electrode 203 may range from 0.4 to 0.95 times the height h1 of the barrier rib 212, the image quality and the driving efficiency are good. Further, in case that the interval g1 between the first electrode 202 and the second electrode 203 may range from 0.52 to 0.86 times the height h1 of the barrier rib 212, the image quality and the driving efficiency are excellent.

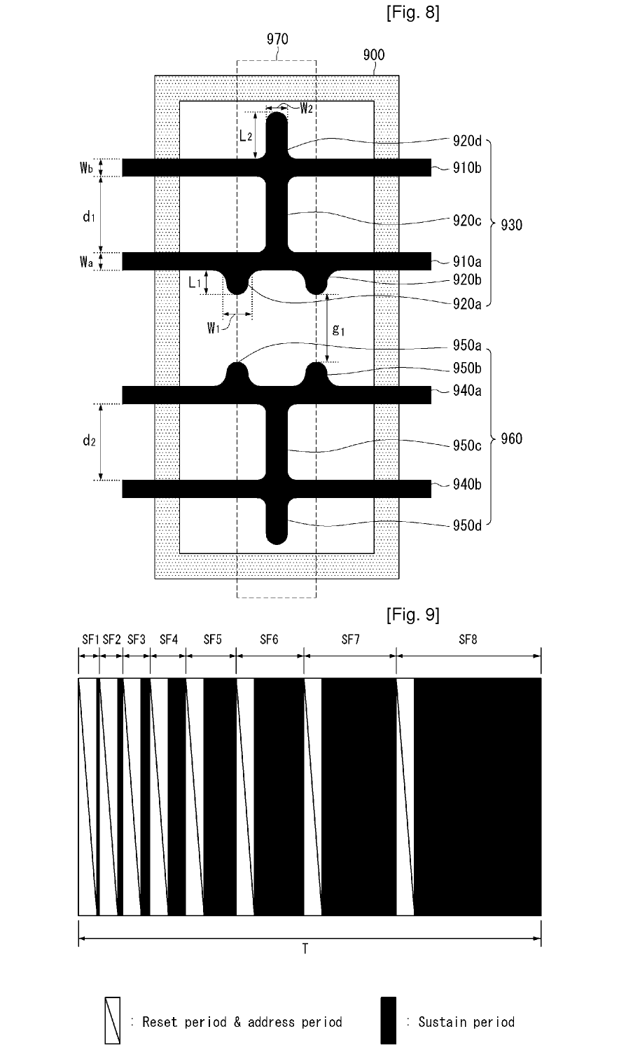

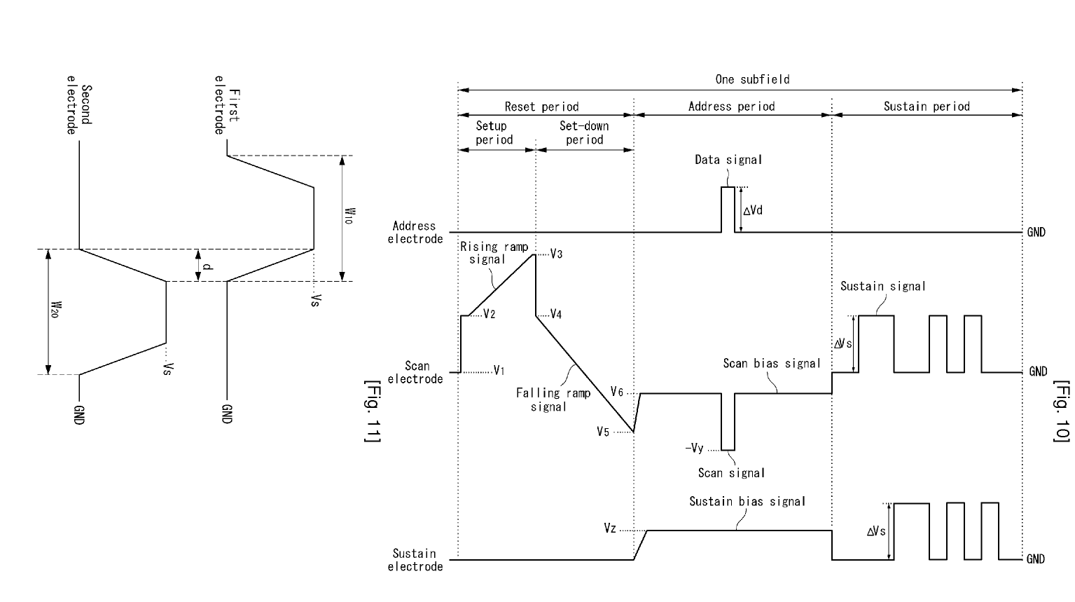

FIG. 8 shows the structure of the first and second electrodes of FIGS. 4 and 7. As shown in FIG. 8, at least one of a first electrode 930 or a second electrode 960 includes line portions 910a, 910b, 940a, and 940b, and projecting portions 920a, 920b, 920d, 950a, 950b, and 950d projecting from the line portions 910a, 910b, 940a, and 940b. At least one of the first electrode 930 or the second electrode 960 may include one layer which is a bus electrode.

The line portions 910a, 910b, 940a, and 940b may be positioned to intersect a third electrode 970 inside a discharge cell partitioned by a barrier rib 900. The line portions 910a, 910b, 940a, and 940b may be spaced apart from each other at predetermined distances d1 and d2. The predetermined distances d1 and d2 may be substantially equal to or different from each other. The line portions 910a, 910b, 940a, and 940b each have predetermined widths Wa and Wb. The projecting portions 920a, 920b, 950a, and 950b may be positioned parallel to the third electrode 970.

Since an interval between the first electrode 930 and the second electrode 960 is reduced due to the projecting portions 920a, 920b, 950a, and 950b, a firing voltage between the first electrode 930 and the second electrode 960 may be lowered.

In FIG. 8, the interval between the first electrode 930 and the second electrode 960 may be an interval g1 between the projecting portions 920b and 950b or an interval between the projecting portions 920a and 950a.

As described with reference to FIGS. 6 and 7, the interval g1 between the first projecting portions 920a and 920b of the first electrode 930 and the first projecting portions 950a and 950b of the second electrode 960 may range from 0.4 to 0.95 times or 0.52 to 0.86 times an interval between an upper dielectric layer and a lower dielectric layer or a height of a barrier rib.

A discharge generated between the first projecting portions 920a and 920b of the first electrode 930 and the first projecting portions 950a and 950b of the second electrode 960 is diffused into the entire area of the discharge cell through the first and second line portions 910a and 910b of the first electrode 930 and the first and second line portions 940a and 940b of the second electrode 960.

The number of projecting portions of each of the first electrode 730 and the second electrode 760 may vary. The first electrode 930 and the second electrode 960 may further include connection portions 920c and 950c connecting at least two of the plurality of line portions 910a, 910b, 940a, and 940b to each other. The connection portions 920c and 950c make the diffusion of discharge smoother.

The first projecting portions 920a, 920b, 950a, and 950b of the first and second electrodes 930 and 960 project in a first direction, i.e., in a direction toward the center of the discharge cell, and the second projecting portions 920d and 950d project in a second direction opposite the first direction. The first projecting portions 920a, 920b, 950a, and 950b and the second projecting portions 920d and 950d projecting in the first and second directions make the diffusion of discharge smooth.

A width W1 of the first projecting portions 920a, 920b, 950a, and 950b may be substantially equal to or different from a width ¶2 of the second projecting portions 920d and 950d. A length L1 of the first projecting portions 920a, 920b, 950a, and 950b may be different from a length L2 of the second projecting portions 920d and 950d. At least one of the plurality of projecting portions 920a, 920b, 920d, 950a, 950b, and 950d may have the curvature. A portion where the projecting portions 920a, 920b, 920d, 950a, 950b, and 950d adjoin the line portions 910a, 910b, 940a and 940b may have the curvature. Further, a portion where the line portions 910a, 910b, 940a and 940b adjoin the connection portions 920c and 950c may have the curvature.

Since FIG. 8 shows the electrode structure of the plasma display panel of FIGS. 4 and 7, the interval between the first electrode and the second electrode ranges from 0.4 to 0.95 times the interval between the upper dielectric layer and the lower dielectric layer and the height of the barrier rib.

As shown in FIG. 9, one frame may be divided into a plurality of subfields SF1 to SF8, so as to achieve a gray scale of an image in the plasma display apparatus according to the exemplary embodiment of the present invention.

Each subfield is subdivided into a reset period for initializing the discharge cells, an address period for selecting discharge cells to be discharged, and a sustain period for representing a gray scale.

A gray level weight of the corresponding subfield may be set by adjusting the number of sustain signals supplied during the sustain period. In other words, a gray level weight having a predetermined value may be assigned to each subfield using the sustain period. For instance, in such a method of setting a gray level weight of a first subfield to 2° and a gray level weight of a second subfield to 2¹, a gray level weight of each subfield increases in a ratio of 2ⁿ (where n=0, 1, 2, 3, 4, 5, 6, 7). In other words, gray scale of variable images is achieved by adjusting the number of sustain signals during the sustain period of each subfield depending on the gray level weight of each subfield.

Although FIG. 9 has shown and described the case where one frame includes 8 subfields, the number of subfields constituting one frame may variably changed. Further, although FIG. 9 has illustrated and described the subfields arranged in increasing order of gray level weight, the subfields may be arranged in decreasing order of gray level weight.

As shown in FIG. 10, during a setup period of a reset period for initialization, a rising ramp signal, which sharply rises from a first voltage V1 to a second voltage V2 and then gradually rises from the second voltage V2 to a third voltage V3, is supplied to the first electrode. The first voltage V1 may be a ground level voltage GND.

The rising ramp signal generates a weak dark discharge (i.e., a setup discharge) inside the discharge cell during the setup period, thereby accumulating a proper amount of wall charges inside the discharge cell.

During a set-down period flowing the setup period, a falling ramp signal of a polarity opposite a polarity of the rising ramp signal is supplied to the first electrode.

The falling ramp signal may gradually fall from a fourth voltage V4 lower than a peak voltage (i.e., the third voltage V3) of the rising ramp signal to a fifth voltage V5.

The supply of the falling ramp signal generates a weak erase discharge (i.e., a set-down discharge) inside the discharge cell. Hence, the remaining wall charges are uniform inside the discharge cells to the extent that an address discharge occurs stably.

During an address period following the reset period, a scan bias signal, which is substantially maintained at a voltage (i.e., a sixth voltage V6) higher than a lowest voltage (i.e., the fifth voltage V5) of the falling ramp signal, is supplied to the first electrode.

A scan signal falling from the scan bias signal by a scan voltage ΔVy may be supplied to the first electrode.

A width of the scan signal may vary in each subfield. A width of a scan signal in at least one subfield may be different from widths of scan signals in the other subfields. A width of a scan signal in a subfield may be larger than a width of a scan signal in a next subfield in time order.

When the scan signal is supplied to the first electrode, a data signal, which rises by a magnitude ΔVd of the data voltage to correspond to the scan signal, may be supplied to the third electrode.

As the voltage difference between the scan signal and the data signal is added to a wall voltage by the wall charges produced during the reset period, the address discharge may occur inside the discharge cell to which the data signal is supplied.

A sustain bias signal may be supplied to the second electrode during the address period so as to prevent the address discharge from being unstable by interference of the second electrode.

The sustain bias signal may be substantially maintained at a sustain bias voltage Vz, which is lower than a voltage of a sustain signal supplied during a sustain period and is higher than the ground level voltage GND.

During the sustain period for image display, the sustain signal may be supplied to at least one of the first electrode and the second electrode. For instance, the sustain signal may be alternately supplied to the first electrode and the second electrode.

As the wall voltage inside the discharge cell selected by performing the address discharge is added to the sustain voltage Vs of the sustain signal, every time the sustain signal is supplied, a sustain discharge, i.e., a display discharge occurs between the first electrode and the second electrode.

It is preferable that the sustain signal supplied to the first electrode overlaps the sustain signal supplied to the second electrode during the sustain period. This will be below described in detail.

As shown in FIG. 11, a sustain signal supplied to the first electrode overlaps a sustain signal supplied to the second electrode during a period d of a sustain period.

As described with reference to FIGS. 6 and 7, if the interval between the first electrode and the second electrode is excessively smaller than the interval between the upper dielectric layer and the lower dielectric layer or the height of the barrier rib, the positive column region is not used. Hence, the driving efficiency may be reduced.

In case that a sustain signal supplied to the first electrode overlaps a sustain signal supplied to the second electrode, wall charges produced by the sustain signal supplied to the first electrode may contribute to a sustain discharge generated by the sustain signal supplied to the second electrode. Therefore, although the interval between the first electrode and the second electrode is excessively smaller than the interval between the upper and lower dielectric layers or the height of the barrier rib, a reduction in the driving efficiency can be prevented.

It is preferable that at least one of a width W10 of the sustain signal supplied to the first electrode or a width W20 of the sustain signal supplied to the second electrode ranges from 4.0 μs to 6.0 μs.

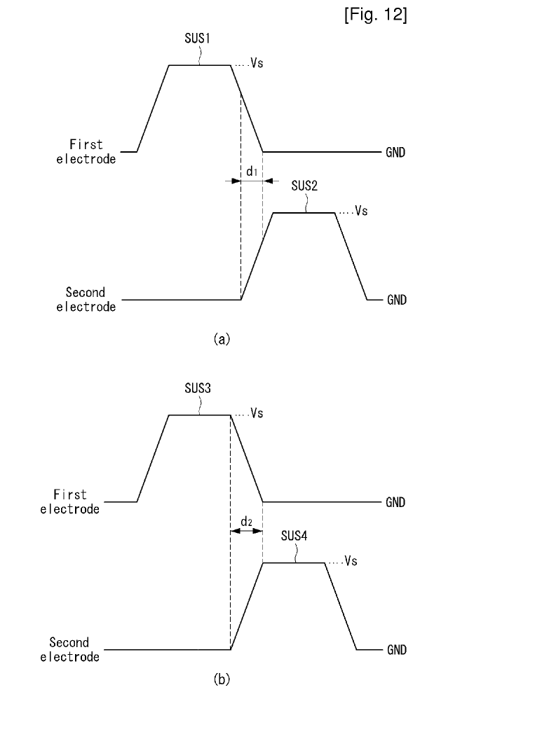

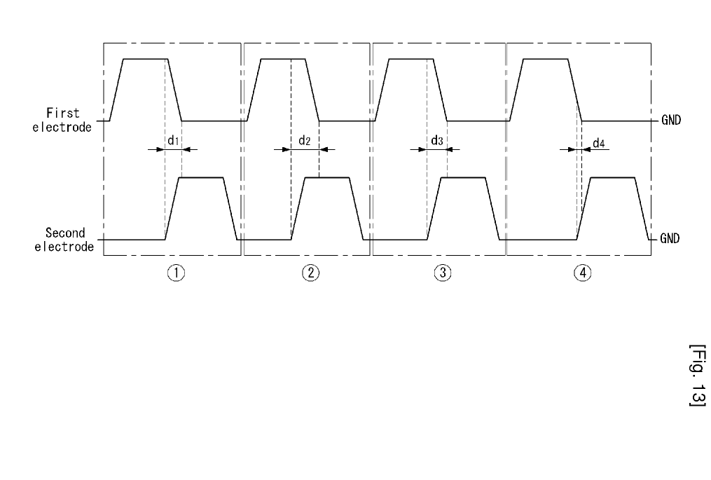

As shown in (a) of FIG. 12, in case that a first sustain signal SUS1 is supplied to the first electrode, and then a second sustain signal SUS2 is supplied to the second electrode, the first sustain signal SUS1 may overlap the second sustain signal SUS2 during a period d1. As shown in (b) of FIG. 12, in case that a third sustain signal SUS3 is supplied to the first electrode, and then a fourth sustain signal SUS4 is supplied to the second electrode, the third sustain signal SUS3 may overlap the fourth sustain signal SUS4 during a period d2 longer than the period d1. As above, a time width of the overlap period of the sustain signals supplied to the first and second electrodes may vary.

If the sustain signals having the overlap period d1 and the sustain signals having the overlap period d2 are used together, a fixed state of the wall charges distributed in the discharge cell can be prevented. Hence, image sticking is reduced. The first and second sustain signals SUS1 and SUS2 having the overlap period d1 may be supplied in at least one of a plurality of subfields of a frame, and the third and fourth sustain signals SUS3 and SUS4 having the overlap period d2 may be supplied in the other subfields.

As shown in FIG. 13, sustain signals having different overlap periods d1, d2, d3, and d4 may be supplied during one sustain period. The driving efficiency is improved and the generation of image sticking is reduced by supplying the sustain signals having the different overlap periods.

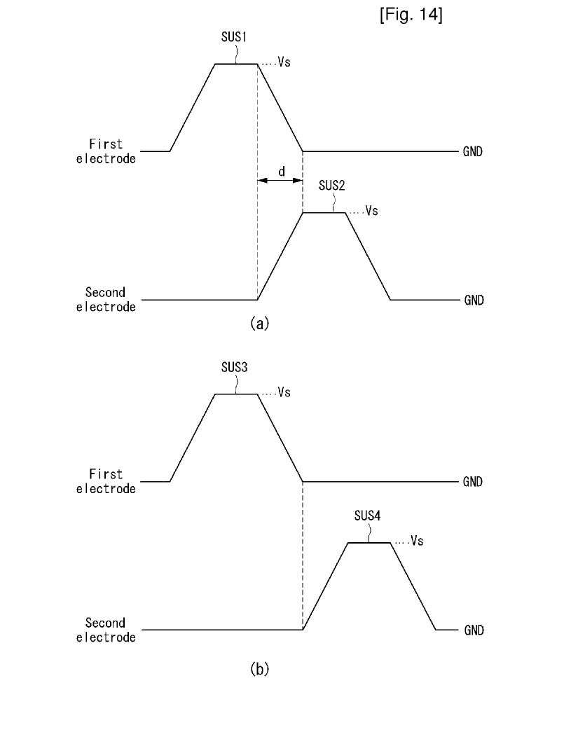

As shown in (a) of FIG. 14, in case that a first sustain signal SUS1 is supplied to the first electrode, and then a second sustain signal SUS2 is supplied to the second electrode, the first sustain signal SUS1 may overlap the second sustain signal SUS2 during a period d. As shown in (b) of FIG. 14, in case that a third sustain signal SUS3 is supplied to the first electrode, and then a fourth sustain signal SUS4 is supplied to the second electrode, the third sustain signal SUS3 may not overlap the fourth sustain signal SUS4.

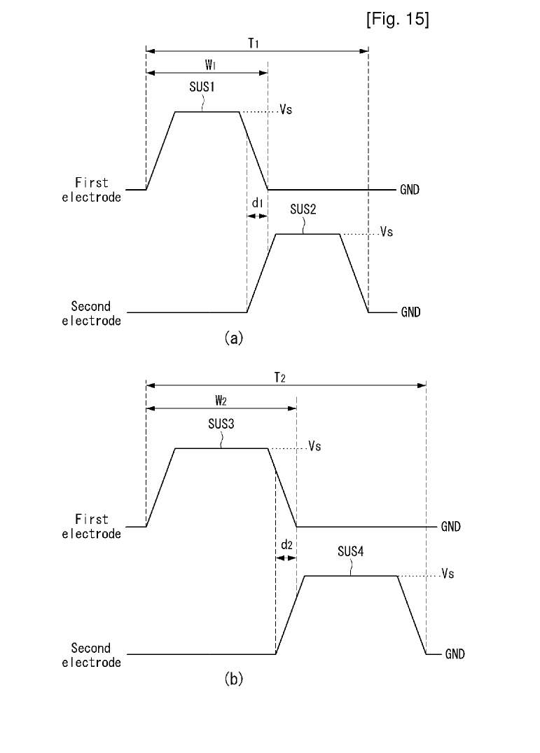

As shown in (a) of FIG. 15, in case that a first sustain signal SUS1 is supplied to the first electrode, and then a second sustain signal SUS2 is supplied to the second electrode, the first sustain signal SUS1 overlaps the second sustain signal SUS2 during a period d1. A width of the first sustain signal SUS1 and the second sustain signal SUS2 is W1, and a cycle of the sustain signal is T1.

As shown in (b) of FIG. 15, in case that a third sustain signal SUS3 is supplied to the first electrode, and then a fourth sustain signal SUS4 is supplied to the second electrode, the third sustain signal SUS3 overlaps the fourth sustain signal SUS4 during a period d2. A width of the first sustain signal SUS1 and the second sustain signal SUS2 is W2 larger than W1, and a cycle of the sustain signal is T2 longer than T1.

As above, in case that the sustain signals supplied to the first and second electrodes overlap and the width and the cycle of the sustain signal change, the generation of image sticking is reduced. Further, a cycle of a sustain signal may vary in each subfield.

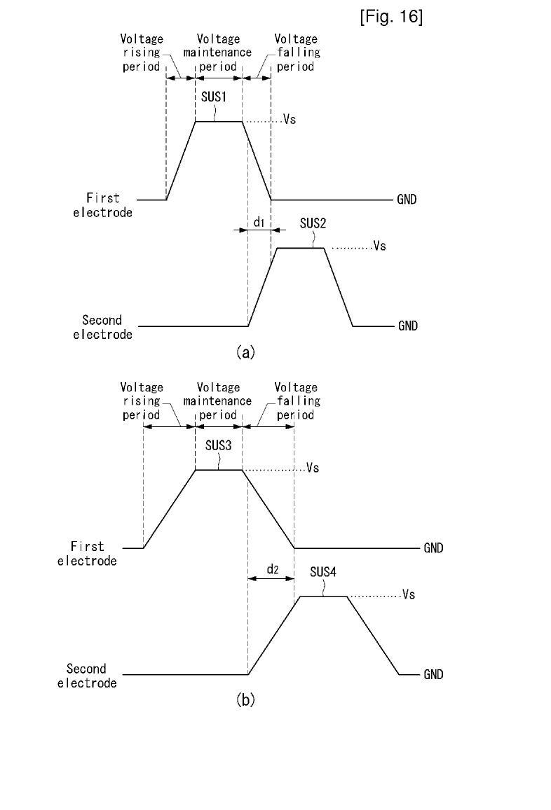

As shown in (a) and (b) of FIG. 16, in case that a first sustain signal SUS1 or a third sustain signal SUS3 is supplied to the first electrode, and then a second sustain signal SUS2 or a fourth sustain signal SUS4 is supplied to the second electrode, the first sustain signal SUS1 overlaps the second sustain signal SUS2 during a period d1 or the third sustain signal SUS3 overlaps the fourth sustain signal SUS4 during a period d2. The first to fourth sustain signals SUS1 to SUS4 may each include a voltage rising period, a voltage maintenance period, and a voltage falling period.

A time width of at least one of the voltage rising periods, the voltage maintenance periods, and the voltage falling periods of the third sustain signal SUS3 and the fourth sustain signal SUS4 may be longer than a time width of at least one of the voltage rising periods, the voltage maintenance periods, and the voltage falling periods of the first sustain signal SUS1 and the second sustain signal SUS2.

When the sustain signals supplied to the first and second electrodes overlap each other, and a time width of at least one of the voltage rising period, the voltage maintenance period, and the voltage falling period of the sustain signal changes, the generation of image sticking is reduced.

1. A plasma display panel comprising:
a front panel including a first electrode, a second electrode, and an upper dielectric layer covering the first and second electrodes; and
a rear panel including a lower dielectric layer covering a third electrode,
wherein an interval between the first electrode and the second electrode ranges from 0.4 to 0.95 times an interval between the upper dielectric layer and the lower dielectric layer.

2. The plasma display panel of claim 1, wherein the interval between the first electrode and the second electrode ranges from 0.52 to 0.68 times the interval between the upper dielectric layer and the lower dielectric layer.

3. The plasma display panel of claim 1, wherein a phosphor layer is positioned between barrier ribs of the rear panel, and a thickness of the phosphor layer ranges from 8 μm to 20 μm.

4. The plasma display panel of claim 1, wherein the rear panel includes a barrier rib partitioning a discharge cell, and the interval between the first electrode and the second electrode ranges from 0.4 to 0.95 times a height of the barrier rib.

5. The plasma display panel of claim 4, wherein the interval between the first electrode and the second electrode ranges from 0.52 to 0.86 times the height of the barrier rib.

6. The plasma display panel of claim 4, wherein the first electrode and the second electrode each include a line portion, and a projecting portion projecting from the line portion, and
an interval between the projecting portion of the first electrode and the projecting portion of the second electrode ranges from 0.4 to 0.95 times the height of the barrier rib.

7. The plasma display panel of claim 6, wherein at least one of the first electrode or the second electrode includes one layer.

8. The plasma display panel of claim 6, wherein the interval between the projecting portion of the first electrode and the projecting portion of the second electrode ranges from 0.52 to 0.86 times the height of the barrier rib.

9. The plasma display panel of claim 6, wherein a phosphor layer is positioned between the barrier ribs, and a thickness of the phosphor layer ranges from 8 μm to 20 μm.

10. A plasma display apparatus comprising:
a plasma display panel including a front panel including a first electrode, a second electrode, and an upper dielectric layer covering the first and second electrodes, and a rear panel including a lower dielectric layer covering a third electrode; and
a driver that supplies sustain signals overlapping each other to the first electrode and the second electrode,
wherein an interval between the first electrode and the second electrode ranges from 0.4 to 0.95 times an interval between the upper dielectric layer and the lower dielectric layer.

11. The plasma display apparatus of claim 10, wherein the interval between the first electrode and the second electrode ranges from 0.52 to 0.68 times the interval between the upper dielectric layer and the lower dielectric layer.

12. The plasma display apparatus of claim 10, wherein the rear panel includes a barrier rib partitioning a discharge cell, and the interval between the upper dielectric layer and the lower dielectric layer is substantially equal to a height of the barrier rib.

13. The plasma display apparatus of claim 10, wherein the rear panel includes a phosphor layer, and a thickness of the phosphor layer ranges from 8 μm to 20 μm.

14. The plasma display apparatus of claim 10, wherein the rear panel includes a barrier rib partitioning a discharge cell, and the interval between the first electrode and the second electrode ranges from 0.4 to 0.95 times a height of the barrier rib.

15. The plasma display apparatus of claim 10, wherein the rear panel includes a barrier rib partitioning a discharge cell, and the first electrode and the second electrode each include a line portion, and a projecting portion projecting from the line portion, and
an interval between the projecting portion of the first electrode and the projecting portion of the second electrode ranges from 0.4 to 0.95 times a height of the barrier rib.
